(19) United States
(12) Patent Application Publication
(10) Pub. No.: US 2024/0263413 A1
(43) Pub. Date: Aug. 8, 2024

(54) OUTDOOR POWER EQUIPMENT AND RELATED METHODS

(71) Applicant: Greenworks (Jiangsu) Co., Ltd, Changzhou (CN)

(72) Inventors: David Edward Chreene, Mooresville, NC (US); Nicholas Dane Suchoza, Mooresville, NC (US); Christopher Jon Eichel, Mooresville, NC (US); Ryan Mark Murphy, Mooresville, NC (US); Jason Michael Swanson, Mooresville, NC (US); Yin Chen, Changzhou (CN)

(21) Appl. No.: 18/638,740

(22) Filed: Apr. 18, 2024

Related U.S. Application Data
(63) Continuation of application No. PCT/US2022/047091, filed on Oct. 19, 2022.
(60) Provisional application No. 63/257,219, filed on Oct. 19, 2021.

(51) Int. Cl. E01H 5/09; B60L 1/00; B60L 15/20; B60L 53/80

(52) U.S. Cl. CPC E01H 5/098; B60L 1/00; B60L 15/20; B60L 53/80; B60L 2240/12

(57) ABSTRACT

Outdoor power equipment includes: a first wheel assembly including a first hub motor and coupled to a first side of the outdoor power equipment; a second wheel assembly including a second hub motor coupled to a second side of the outdoor power equipment; and a battery coupled to the first hub motor and the second hub motor and configured to supply electrical power to the first hub motor and the second hub motor; wherein the first hub motor is configured to rotate the first wheel assembly to drive the outdoor power equipment; and wherein the second hub motor is configured to rotate the second wheel assembly to drive the outdoor power equipment.

### CROSS REFERENCE TO RELATED APPLICATIONS

The present application is a Continuation Application of PCT Application No. PCT/US2022/047091 filed on Oct. 19, 2022, which claims the benefit of U.S. Patent Application No. 63/257,219 filed on Oct. 19, 2021. All the above are hereby incorporated by reference in their entirety.

### TECHNICAL FIELD

The present disclosure generally relates to outdoor power equipment and, more particularly, to battery powered outdoor power equipment such as snow throwers, and related methods.

### BACKGROUND

Traditional self-propelled outdoor power equipment such as snow throwers use gasoline powered internal combustion engines. For example, two and three stage self-propelled snow throwers using an internal combustion engines require relatively large, heavy, and complex gearboxes in order to provide power to one or more augers, an impeller, and one or more drive wheels. Further, since snow throwers are typically used less than six months out of the year, fluids (especially gasoline) and seals sitting idle for extended periods may degrade when the snow thrower is stored. Additionally, internal combustion engines may be difficult to start during cold weather, which coincidentally, is when a snow thrower would be expected to operate. To overcome starting issues, many gasoline powered snow throwers include an electric starter operating on power from an on-board battery or power supplied by an extension cord plugged into an electrical outlet. On-board batteries need to be maintained and charged to operate properly when needed. Other types of self-propelled outdoor power equipment may see intermittent use and experience similar operational and maintenance challenges. Alternate manners of powering self-propelled power equipment, such as snow throwers, using electric motors powered by rechargeable batteries, may provide cost and operational benefits.

Accordingly, and in spite of the various advances already made in this field, there is a need for further improvements related to devices and methods for battery powered outdoor power equipment such as battery powered snow throwers.

### SUMMARY

Generally, outdoor power equipment is described and comprises a first wheel assembly comprising a first hub motor and coupled to a first side of the outdoor power equipment, a second wheel assembly comprising a second hub motor coupled to a second side of the outdoor power equipment, and a battery coupled to the first hub motor and the second hub motor and configured to supply electrical power to the first hub motor and the second hub motor. The first hub motor is configured to rotate the first wheel assembly to drive the outdoor power equipment and the second hub motor is configured to rotate the second wheel assembly to drive the outdoor power equipment.

In some embodiments, the outdoor power equipment may further comprise a drive speed control coupled to the first hub motor and the second hub motor. The drive speed control may be configured to control the speed of the first wheel assembly and the second wheel assembly. The outdoor power equipment may further comprise an electronic control device coupled to the drive speed control, the first hub motor, and the second hub motor. The drive speed control may provide a signal to the electronic control device. The electronic control device may be configured to receive a signal from the drive speed control and may control the speed of the first wheel assembly and the second wheel assembly based at least in part on the signal from the drive speed control.

In alternative or additional aspects, the rotation of the first wheel assembly and the second wheel assembly of the outdoor power equipment may be controlled independently. The outdoor power equipment may further comprise a first hand operated drive control mechanism coupled to the first hub motor and a second hand operated drive control mechanism coupled to the second hub motor. The first hand operated drive control mechanism may be configured to control the rotation of the first wheel assembly. The second hand operated drive control mechanism may be configured to control the rotation of the second wheel assembly. Operating the first hand operated drive control mechanism may control the rotation of the first wheel assembly and controlling the rotation of the first wheel assembly may turn the outdoor power equipment in a first direction. Operating the second hand operated drive control mechanism may control the rotation of the second wheel assembly and controlling the rotation of the second wheel assembly may turn the outdoor power equipment in a second direction. The hand operated drive control mechanism may be any desired movable mechanism that allows the operator to control a powered wheel of the equipment. For example, the hand operated drive control mechanism may be a lever. The term “lever” as used herein encompasses any structures or mechanisms that act through pushing and/or pulling and moving the lever through sliding, pivoting or other motion.

In some embodiments, the outdoor power equipment may further comprise an electronic control device coupled to the first hand operated drive control mechanism, the second hand operated drive control mechanism, the first hub motor, and the second hub motor. The first hand operated drive control mechanism may provide a signal to the electronic control device. The electronic control device may be configured to receive a signal from the first hand operated drive control mechanism and may control the rotation of the first wheel assembly based at least in part on the signal from the first hand operated drive control mechanism. The second hand operated drive control mechanism may provide a signal to the electronic control device. The electronic control device may be configured to receive a signal from the second hand operated drive control mechanism and may control the rotation of the second wheel assembly based at least in part on the signal from the second hand operated drive control mechanism.

In alternative or additional aspects, operating both the first hand operated drive control mechanism and the second hand operated drive control mechanism at the same time may control the rotation of the first wheel assembly and the second wheel assembly in a reverse rotation direction and may drive the outdoor power equipment in a reverse direction. Releasing either or both of the first hand operated drive control mechanism and the second hand operated drive control mechanism may stop both the first wheel assembly and the second wheel assembly from rotating in a reverse rotation direction and may stop driving the outdoor power equipment in a reverse direction.

In alternate embodiments, the outdoor power equipment may further comprise a hand operated drive mechanism coupled to the first hub motor and the second hub motor and may be configured to control the operation of the first hub motor and the second hub motor. Operating the hand operated drive mechanism may allow the first wheel assembly and the second wheel assembly to drive the outdoor power equipment. The outdoor power equipment may further comprise an electronic control device coupled to the hand operated drive mechanism, the first hub motor, and the second hub motor. The hand operated drive mechanism may provide a signal to the electronic control device. The electronic control device may be configured to receive a signal from the hand operated drive mechanism and may control the rotation of the first wheel assembly and the second wheel assembly based at least in part on the signal from the hand operated drive mechanism.

In alternative or additional aspects, the outdoor power equipment may further comprise a battery charge indicator coupled to the battery and configured to provide a perceptible indication of a remaining battery electrical charge. In some embodiments, the battery may be removed from the outdoor power equipment for recharging.

In alternate embodiments, the outdoor power equipment may further comprise an auger rotatably coupled to the outdoor power equipment and configured to move snow and an auger drive motor coupled to the auger and the battery and configured to drive the auger. The battery may be configured to supply electrical power to the auger drive motor. The outdoor power equipment may further comprise an auger speed control coupled to the auger drive motor. The auger speed control may be configured to control the speed of the auger. The outdoor power equipment may further comprise an electronic control device coupled to the auger speed control and the auger drive motor. The auger speed control may provide a signal to the electronic control device. The electronic control device may be configured to receive a signal from the auger speed control and control the speed of the auger based at least in part on the signal from the auger speed control. The outdoor power equipment may further comprise a hand operated auger control mechanism coupled to the auger drive motor and configured to control the operation of the auger drive motor. Operating the hand operated auger control mechanism may allow the auger drive motor to drive the auger.

The outdoor power equipment may further comprise an electronic control device coupled to the hand operated auger control mechanism and the auger drive motor. The hand operated auger control mechanism may provide a signal to the electronic control device. The electronic control device may be configured to receive a signal from the hand operated auger control mechanism and may control the auger drive motor based at least in part on the signal from the hand operated auger control mechanism.

In some embodiments, the outdoor power equipment may further comprise a discharge chute rotatably coupled to the outdoor power equipment and a discharge chute rotation handle coupled to the discharge chute. The discharge chute may be rotated by moving the discharge chute rotation handle. the discharge chute rotation handle may be configured to prevent rotation of the discharge chute when the discharge chute rotation handle is in a locked position.

Additional aspects and advantages of the invention will become more apparent upon further review of the detailed description of the illustrative embodiments taken in conjunction with the accompanying drawings.

### BRIEF DESCRIPTION OF THE DRAWINGS

FIG. 1 is a perspective view of an illustrative battery powered self-propelled snow thrower.

FIG. 2 is an alternate perspective view of the illustrative snow thrower of FIG. 1.

FIG. 3 is an alternate perspective view of the illustrative snow thrower of FIGS. 1 and 2.

FIG. 4 is a plan view of an illustrative control panel of a battery powered self-propelled snow thrower.

FIG. 5 is a perspective view of the illustrative control panel of FIG. 4.

FIG. 6 is an alternate perspective view of the illustrative control panel of FIGS. 4 and 5.

FIG. 7 is a section view of the illustrative snow thrower, the section traversing wheel assemblies and a battery assembly.

FIG. 8 is a section view of the illustrative snow thrower, the section traversing an auger assembly.

FIG. 9 is a front view of the illustrative snow thrower of FIGS. 1-3.

FIGS. 10A-10G are perspective views of the illustrative snow thrower of FIGS. 1-3 with a chute assembly in various positions.

FIGS. 11A and 11B are perspective views of the illustrative snow thrower of FIGS. 1-3 with a snow deflector in various positions.

FIG. 12 is a perspective view of the illustrative snow thrower of FIGS. 1-3 with a battery cover in an open position.

FIG. 13 is an alternate perspective view of the illustrative snow thrower of FIGS. 1-3 with the battery cover in an open position.

FIG. 14 is a simplified block diagram of an exemplary self-propelled snow thrower.

### DETAILED DESCRIPTION

Illustrative embodiments according to at least some aspects of the present disclosure are described and illustrated below and include outdoor power equipment and related methods. It will be apparent to those of ordinary skill in the art that the embodiments discussed below are examples and may be reconfigured without departing from the scope and spirit of the present disclosure. It is also to be understood that variations of the exemplary embodiments contemplated by one of ordinary skill in the art shall concurrently comprise part of the instant disclosure. The illustrative embodiments as discussed below may include optional steps, methods, and features that one of ordinary skill should recognize as not being a requisite to fall within the scope of the present disclosure.

The present disclosure includes, among other things, outdoor power equipment, and related methods. Some illustrative embodiments according to at least some aspects of the present disclosure are described below in the context of a battery powered self-propelled snow thrower. It will be appreciated, however, that similar systems and methods may be utilized in connection with other battery powered outdoor power equipment and other devices such as outdoor power equipment for snow removal.

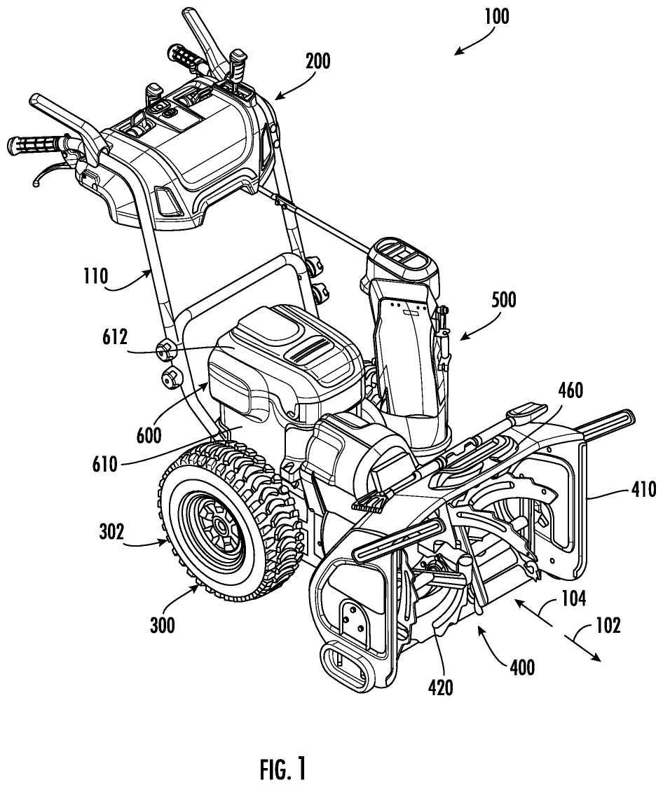

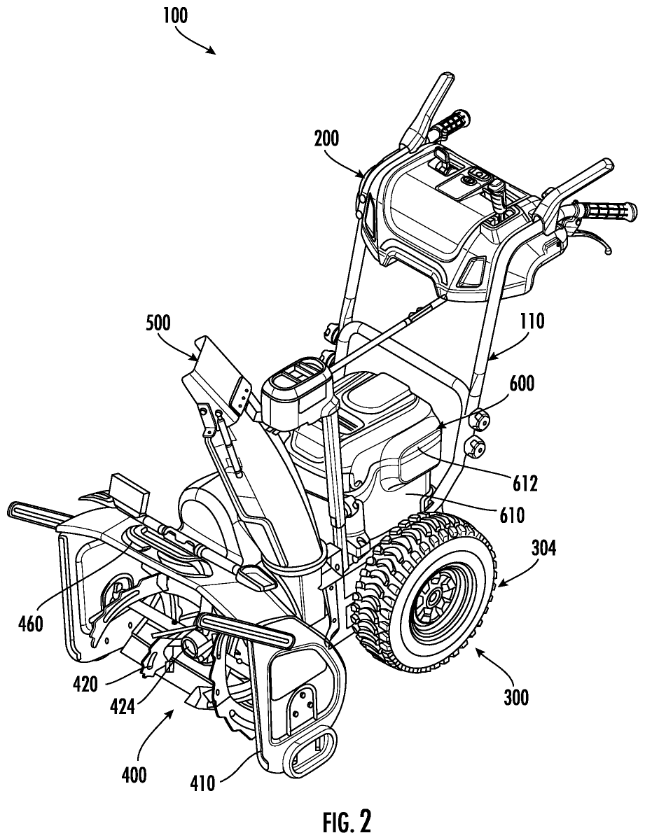

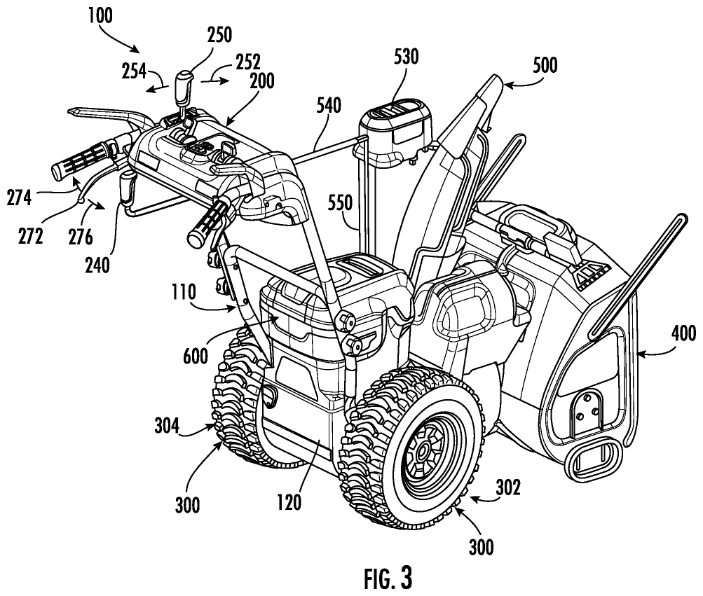

FIG. 1 is a perspective view of an illustrative battery powered self-propelled snow thrower 100, FIG. 2 is an alternate perspective view of the illustrative snow thrower 100, FIG. 3 is an alternate perspective view of the illustrative snow thrower 100, all according to at least some aspects of the present disclosure.

Referring to FIGS. 1-3, in this exemplary embodiment, snow thrower 100 includes a handle assembly 110, a chassis 120, a control panel 200, an auger assembly 400, a chute assembly 500, and a battery assembly 600. As used herein, the term “battery” or “battery assembly” encompasses the use of one or more batteries to power one or more components of an item of outdoor power equipment. In this illustrative example, the orientation of the snow thrower 100 generally and the control panel 200 specifically are given from the perspective of a user. The right side of the snow thrower 100 generally and the right side of the control panel 200 specifically being located proximately to the right side of the user and the right side controls would be controlled and/or operated by the user's right hand. The left side of the snow thrower 100 generally and left side of the control panel 200 specifically being located proximately to the left side of the user and controlled and/or operated by the user's left hand. The front of the snow thrower 100 is generally at the opening of the auger assembly 400 and the rear of the snow thrower 100 is generally at the user position relative to the control panel 200.

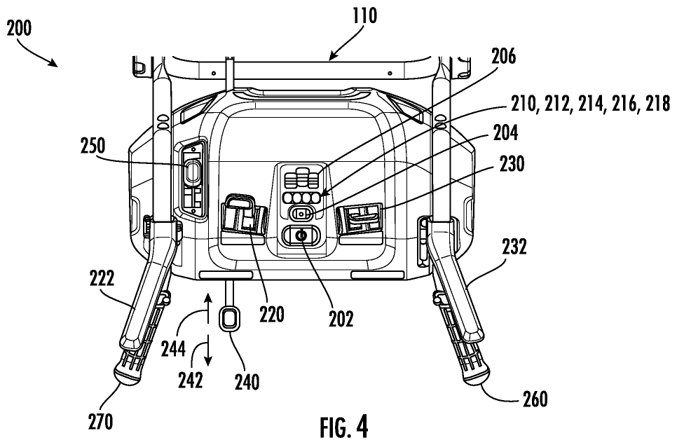

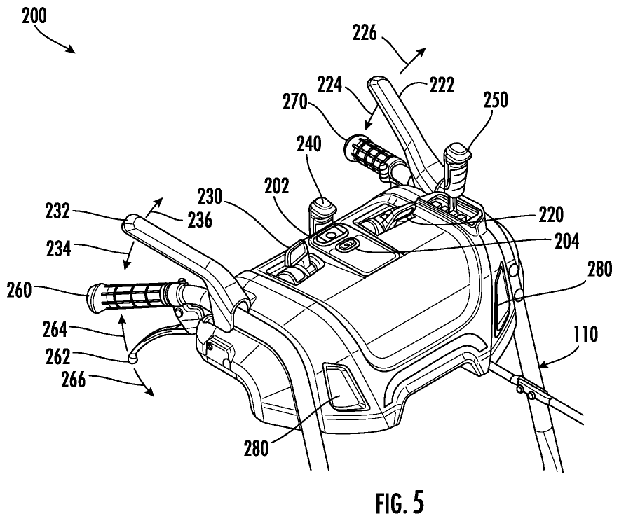

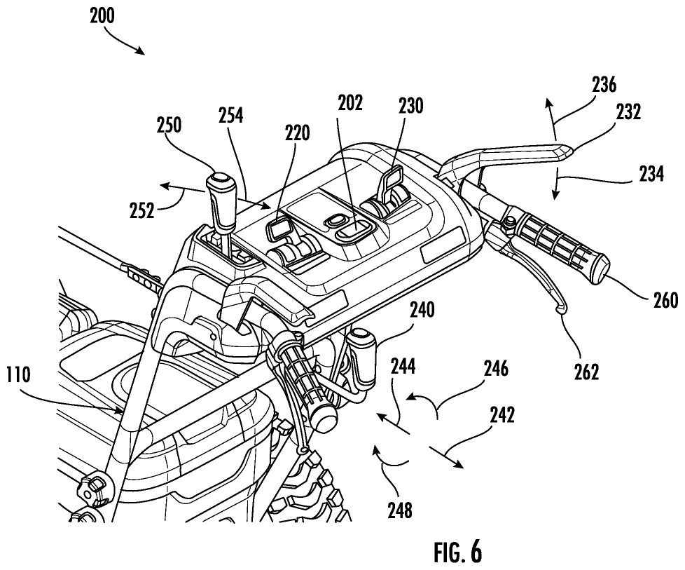

FIG. 4 is a plan view of an illustrative control panel 200 of snow thrower 100, FIG. 5 is a perspective view of the illustrative control panel 200, FIG. 6 is an alternate perspective view of the illustrative control panel 200, all according to at least some aspects of the present disclosure.

Referring to FIGS. 4-6, in this exemplary embodiment, the control panel 200 includes a power switch 202, a power on indicator 204, a battery charge indicator 206, a plurality of headlamp controls 210, a drive speed control 220, a drive lever 222, an auger speed control 230, a hand operated auger control mechanism such as an auger drive lever 232, a chute rotation handle 240, a deflector control handle 250, a right handle 260, a right drive control lever 262, a left handle 270, a left drive control lever 272 (FIG. 3), and one or more control panel lamps 280. The drive control levers 262, 272 allow independent left and right turning control by the user. As discussed above, these levers 262, 272 are hand operated drive control mechanisms and may take other forms as desired for allowing an operator to achieve independent control of right and left powered wheels such as described herein. Other levers as described herein may alternatively comprise mechanisms in forms other than a lever as will be understood. The control panel 200 is coupled to the handle assembly 110. The handle assembly 110 is coupled to the chassis 120. The power switch 202 is coupled to the battery assembly 600. The battery assembly 600 provides electrical power to the snow thrower 100. The power switch 202 may have an on position and an off position. When in the on position, the power switch 202 may connect electrical power to any electrical components of the snow thrower 100 and when in the off position, the power switch 202 may disconnect the power from the electrical components of the snow thrower 100. As used herein, “electrical components” may refer to any device configured to use electrical power. Electrical components, for example, may include motors, lamps, switches, sensors, electronic control devices, and the like. The power on indicator 204 maybe coupled to the power switch 202. The power on indicator 204 may provide a perceptible indication when the power switch 202 is in the on position. The power on indicator 204 may illuminate when the power switch 202 is in the on position, for example.

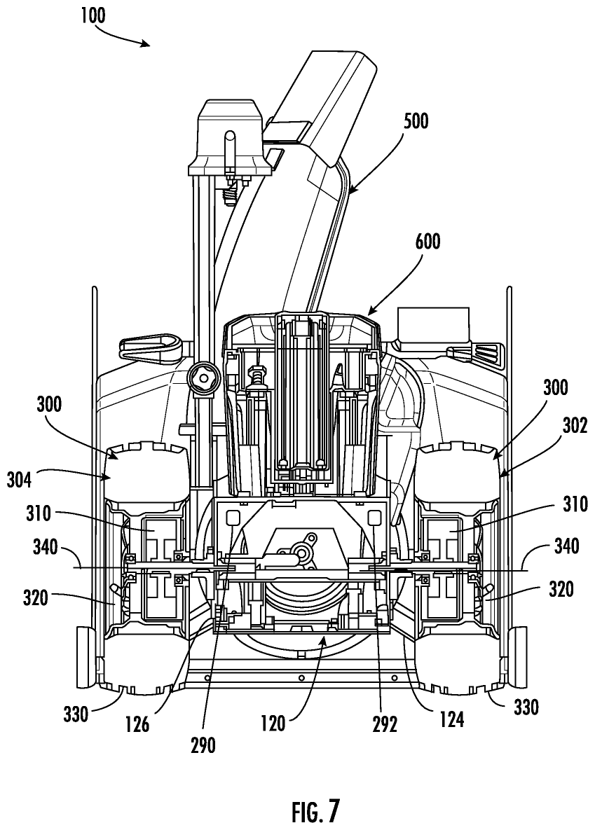

FIG. 7 is a section view of the illustrative snow thrower 100, the section traversing wheel assemblies 302, 304 and the battery assembly 600 according to at least some aspects of the present disclosure. The snow thrower 100 may include one or more wheel assemblies 300. Referring to FIGS. 1-3 and 7, in this illustrative example, snow thrower 100 includes a right wheel assembly 302 coupled to a right side 124 of the chassis 120 and a left wheel assembly 304 coupled to a left side 126 of the chassis 120. In alternate embodiments, snow thrower 100 may include one or more track assemblies instead of wheel assemblies, for example. The wheel assemblies 302, 304 are operative to propel the snow thrower 100. During operation of the snow thrower 100, the wheel assemblies 302, 304 may propel the snow thrower 100 forward, backward, and may assist with steering the snow thrower 100 to the right or left.

In this illustrative example, each wheel assembly 302, 304 includes a hub motor 310, a wheel 320, and a tire 330. The hub motors 310 of the wheel assemblies 302, 304 are respectively coupled to the right and left sides of the chassis 120. The tire 330 is coupled to the wheel 320, and the wheel 320 is coupled to the hub motor 310 of each wheel assembly 302, 304. The wheel 320 and tire 330 rotate around a center axis 340 of the hub motor 310 and during operation the hub motor 310 provides a torque to rotate the wheel 320 and tire 330. In this illustrative example, the wheel assemblies 302, 304 share the same center axis 340. The hub motors 310 may selectively rotate the wheels 320 and tires 330 clockwise and counterclockwise thereby selectively propelling the snow thrower 100 forward and backward. Selectively operating the hub motors 310 may allow a user to steer the snow thrower 100 to the right or left. The hub motors 310 may be electric motors. The hub motors 310 may be variable speed motors, for example. The hub motors 310 may include a plurality of speeds, such as two or three speed motors, for example. In some embodiments, the tires 330 may be pneumatic, for example. In alternate embodiments, the tires 330 may be airless, solid rubber, or foam filled rubber, for example. The wheel 320 may be constructed from metal, plastic, and/or other generally rigid materials. The wheel 320 may be a composite construction, for example, the wheel 320 may have a metallic rim and a plastic disc.

Referring to FIGS. 1-7, in this exemplary embodiment, the drive speed control 220 is a lever and may be used to select a speed of the snow thrower 100. In alternate embodiments, the drive speed control 220 may be a slide or rotatable potentiometer, for example. In alternate embodiments, the drive speed control 220 may be one or more switches, for example. In alternate embodiments, the drive speed control 220 may be a selectable dial, for example. The drive speed control 220 may be coupled to an electronic control device 290. The drive speed control 220 may send a signal to the electronic control device 290. The electronic control device 290 may be mounted in the chassis 120 and may control the speed of the wheel assemblies 302, 304. In this exemplary embodiment, the drive lever 222 is movably coupled to the left handle 270 and may be used to control the power to the wheel assemblies 302, 304. After selecting a speed with the speed control 220, moving the drive lever 222 in the direction of arrow 224 may provide power to the wheel assemblies 302, 304 and cause the wheel assemblies 302, 304 to drive the snow thrower 100 forward in the direction of arrow 102, for example. Releasing the drive lever 222 may allow the drive lever 222 to move in the direction of arrow 226 allowing the drive lever 222 to return to its original position and may shut off the power to the wheel assemblies 302, 304, stopping the forward movement of the snow thrower 100, for example. In some embodiments, the snow thrower 100 may include a reverse function. In some embodiments, the drive lever 222 may provide a signal to the electronic control device 290. The electronic control device 290 may be configured to receive a signal from the drive lever 222 and control the rotation of the wheel assemblies 302, 304 based at least in part on the signal from the drive lever 222.

In this exemplary embodiment, the right drive control lever 262, is movably coupled to the right handle 260 and may be used to control the rotation of the right wheel assembly 302. If, for example, the snow thrower 100 were moving forward in the direction of arrow 102, being driven by the wheel assemblies 302, 304, moving the right drive control lever 262 in the direction of arrow 264 may slow the rotation of the right wheel assembly 302 by reducing the power to the right wheel assembly 302. Reducing the power to the right wheel assembly 302 may cause the snow thrower 100 to gradually turn to the right. The power reduction to the right wheel assembly 302 may be variable depending on the position of the right drive control lever 262, for example. If, for example, the snow thrower 100 were moving forward in the direction of arrow 102, being driven by the wheel assemblies 302, 304, moving the right drive control lever 262 in the direction of arrow 264 may stop the rotation of the right wheel assembly 302 by reducing the power to the right wheel assembly 302 to zero. Reducing the power to the right wheel assembly 302 to zero may cause the snow thrower 100 to turn sharply to the right. Releasing the right drive control lever 262 may allow the right drive control lever 262 to move in the direction of arrow 266 allowing the right drive control lever 262 to return to its original position and allow the rotation of the right wheel assembly 302 to resume the speed selected with the drive speed control 220 and allow the snow thrower 100 to move forward in the direction of arrow 102. In some embodiments, the right drive control lever 262 may provide a signal to the electronic control device 290. The electronic control device 290 may be configured to receive a signal from the right drive control lever 262 and control the rotation of the right wheel assembly 302 based at least in part on the signal from the right drive control lever 262.

In this exemplary embodiment, the left drive control lever 272, is movably coupled to the left handle 270 and may be used to control the rotation of the left wheel assembly 304. If, for example, the snow thrower 100 were moving forward in the direction of arrow 102, being driven by the wheel assemblies 302, 304, moving the left drive control lever 272 in the direction of arrow 274 may slow the rotation of the left wheel assembly 304 by reducing the power to the left wheel assembly 304. Reducing the power to the left wheel assembly 304 may cause the snow thrower 100 to gradually turn to the left. The power reduction to the left wheel assembly 304 may be variable depending on the position of the left drive control lever 272, for example. If, for example, the snow thrower 100 were moving forward in the direction of arrow 102, being driven by the wheel assemblies 302, 304, moving the left drive control lever 272 in the direction of arrow 274 may stop the rotation of the left wheel assembly 304 by reducing the power to the left wheel assembly 304 to zero. Reducing the power to the left wheel assembly 304 to zero may cause the snow thrower 100 to turn sharply to the left. Releasing the left drive control lever 272 may allow the left drive control lever 272 to move in the direction of arrow 276 allowing the left drive control lever 272 to return to its original position and allow the rotation of the left wheel assembly 304 to resume the speed selected with the drive speed control 220 and the snow thrower 100 to move forward in the direction of arrow 102. In some embodiments, the left drive control lever 272 may provide a signal to the electronic control device 290. The electronic control device 290 may be configured to receive a signal from the left drive control lever 272 and control the rotation of the left wheel assembly 304 based at least in part on the signal from the left drive control lever 272.

As described above, the right drive control lever 262 and left drive control lever 272 may allow a user to control the hub motors 310 of the wheel assemblies 302, 304 individually. By independently controlling the hub motors 310, a user may be able to execute a zero-radius turn by stopping the rotation of the wheel assembly 302, 304 on the inside of the turn, for example. In other instances, by independently controlling the hub motors 310, a user may be able to steer the snow thrower 100 by slowing the rotation of wheel assembly 302 and/or wheel assembly 304, for example.

In some embodiments, the right drive control lever 262 and the left drive control lever 272 may be configured to drive the snow thrower 100 in reverse in the direction of arrow 104. For example, moving the right drive control lever 262 in the direction of arrow 264 while at the same time moving the left drive control lever 272 in the direction of arrow 274 may control the rotation of the wheel assemblies 302, 304 in a reverse rotation direction and drive the snow thrower in the direction of arrow 104. Releasing either the right drive control lever 262 or the left drive control lever 272 may cause both of the wheel assemblies 302, 304 to stop rotating in a reverse rotation direction, for example.

FIG. 8 is a section view of the illustrative snow thrower 100, the section traversing the auger assembly 400, and FIG. 9 is a front view of the illustrative snow thrower 100, all according to at least some aspects of the present disclosure. Referring to FIGS. 1-3, 8, and 9, in this exemplary embodiment, the auger assembly 400 includes an auger housing 410, an auger 420, an auger driveshaft 422, an auger gearbox 424, an impeller housing 430, an impeller 440, an auger drive motor 450, and an auger lamp 460. In this exemplary embodiment, the auger assembly 400 is mounted to the front of the chassis 120. The auger 420 is rotatably mounted in the auger housing 410. The auger driveshaft 422 and the impeller 440 are rotatably mounted in the impeller housing 430. In this exemplary embodiment, the auger drive motor 450 is mounted on an upper portion of the impeller housing 430. In this exemplary embodiment, the auger drive motor 440 is located forward of the battery assembly 600. The auger drive motor output shaft 452 may be oriented facing the rear of the snow thrower 100. The axis of the auger driveshaft 422 may be parallel to the axis of the auger drive motor output shaft 452. In this illustrative embodiment, the drive motor 450 is coupled to the auger driveshaft 422 with a belt 454. In some embodiments, the auger drive motor 450 may be coupled to the auger driveshaft 422 with a chain, for example. In some embodiments, the auger drive motor 450 may be coupled to the auger driveshaft 422 with a gear, for example. The mounting location of the auger drive motor 450 and the orientation of the auger drive motor output shaft 452 may allow convenient access to the belt 454 for inspection and maintenance, for example. The auger driveshaft 422 is coupled to the auger gearbox 424 and the auger gearbox 424 is coupled to the auger 420. The impeller 440 is coupled to the auger driveshaft 422 and the auger drive shaft 422 may pass through the center of the impeller 440. Generally, during operation of the snow thrower 100, and specifically the operation of the auger 420, the auger drive motor 450 drives the belt 454 which rotates the auger driveshaft 422 and the impeller 440. The auger driveshaft 422 transmits power through the auger gearbox 424 to rotate the auger 420.

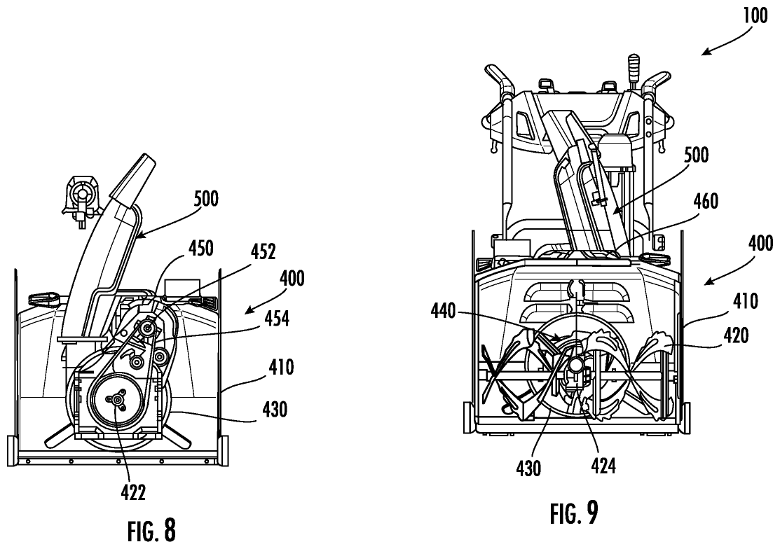

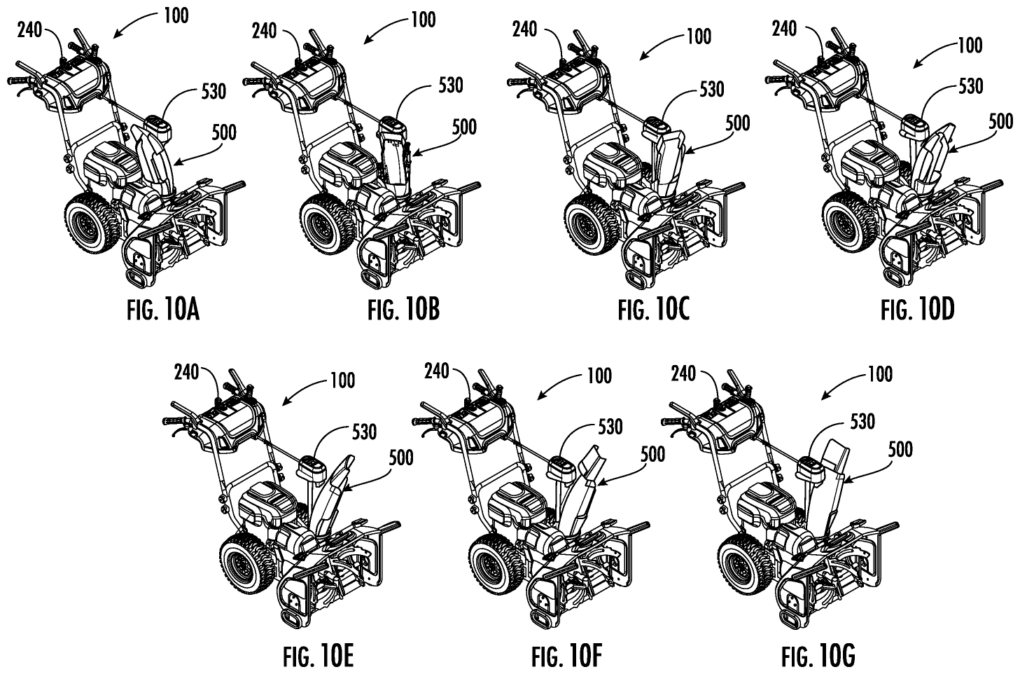

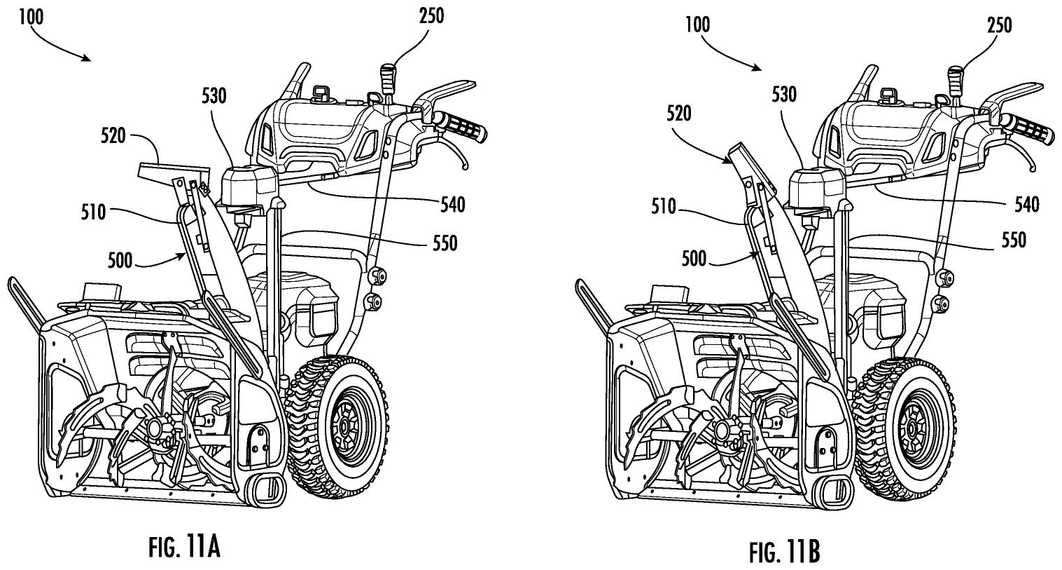

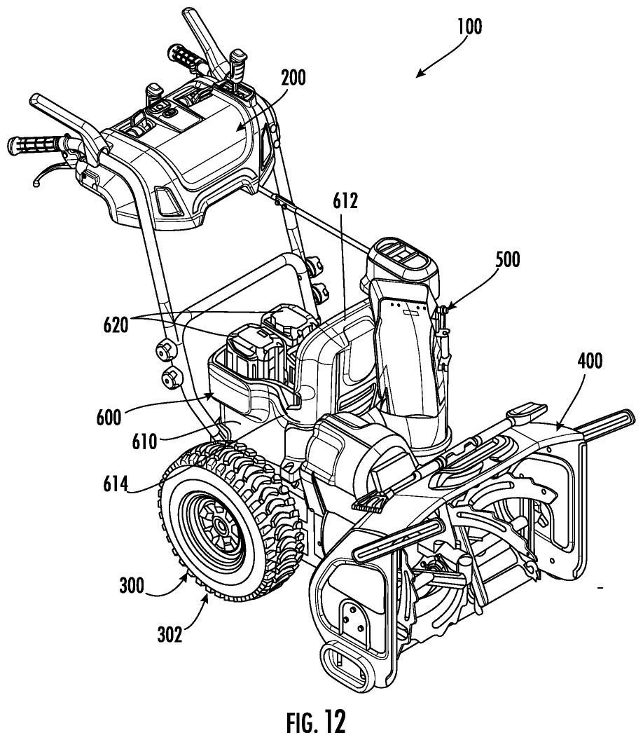

FIGS. 10A-10G are perspective views of the illustrative snow thrower 100 with the chute assembly 500 in various positions and FIGS. 11A and 11B are perspective views of the illustrative snow thrower 100 with the snow deflector 520 in various positions, FIG. 14 is a simplified block diagram of an exemplary self-propelled snow thrower 100, all according to at least some aspects of the present disclosure. Referring to FIGS. 3, 4, 6, 10A-10G, 11A and 11B, in this illustrative embodiment, the chute assembly 500 includes a discharge chute 510, a snow deflector 520, and a chute rotation gearbox 530, a gearbox input shaft 540, and a gearbox output shaft 550. The discharge chute 510 is rotatably coupled to an outlet of the impeller housing 430. The snow deflector 520 is rotatably coupled to the discharge chute 510. The chute rotation handle 240 is coupled to the gearbox input shaft 540, the gearbox input shaft 540 is coupled to the chute rotation gearbox 530, the chute rotation gearbox 530 is coupled to the gearbox output shaft 550, and the gearbox output shaft 550 is coupled to the rotatable connection of the discharge chute 510 to the outlet of the impeller housing 430. Moving chute rotation handle 240 in the direction of arrow 242 may unlock gearbox input shaft 540 allowing chute rotation handle 240 to be rotated in the directions of arrows 246 and 248. Moving the chute rotation handle 240 in the direction of arrow 244, and back to its original position, may lock the gearbox input shaft 540 preventing rotation. In some embodiments, the gearbox input shaft 540 maybe spring loaded, for example, and may automatically return to its original position, in the direction of arrow 244, when released. Rotating the chute rotation handle 240 in the directions of arrows 246 and 248 may rotate the gearbox input shaft 540 thereby rotating the gearbox output shaft 550 through the chute rotation gearbox 530. Rotation of the gearbox output shaft 550 may rotate the rotatable connection of the discharge chute 510 to the outlet of the impeller housing 430. Rotating the chute rotation handle 240 in the directions of arrows 246 and 248 may rotate the chute assembly 500 between the various positions illustrated in FIGS. 10A through 10G. In this illustrative embodiment, the deflector control handle 250 is coupled to the snow deflector 520. Moving the deflector control handle 250 in the directions of arrows 252 and 254 may rotate the snow deflector 520 between the various positions illustrated in FIGS. 11A and 11B.

Referring to FIGS. 1-9 and 14, in this exemplary embodiment, the auger speed control 230 is a lever and may be used to select a speed of the auger 420. In alternate embodiments, the auger speed control 230 may be a slide or rotatable potentiometer, for example. In alternate embodiments, the auger speed control 230 may be one or more switches, for example. In alternate embodiments, the auger speed control 230 may be a selectable dial control, for example. The auger speed control 230 may be coupled to an electronic control device 292. The auger speed control 230 may send a signal to the electronic control device 292. The electronic control device 292 may be mounted in the chassis 120 and may control the speed of the auger 420. In this exemplary embodiment, the auger drive lever 232 is movably coupled to the right handle 260 and may be used to control the power the auger drive motor 450. After selecting an auger speed with the auger speed control 230, moving the auger drive lever 232 in the direction of arrow 234 may provide power to the auger drive motor 450 and cause the auger 420 to rotate thereby drawing snow into the auger housing 410, for example. Once the snow is drawn into the auger housing 410, the auger 420 may direct the snow into the impeller housing 430 and the impeller 440 may direct the snow up through the discharge chute 510. Releasing the auger drive lever 232 may allow the auger drive lever 232 to move in the direction of arrow 236 allowing the auger drive lever 232 to return to its original position and may shut off the power to the auger drive motor 450, stopping the auger 420, for example. In some embodiments, the auger drive lever 232 may provide a signal to the electronic control device 292. The electronic control device 292 may be configured to receive a signal from the auger drive lever 232 and control the power to the auger drive motor 450 based at least in part on the signal from the auger drive lever 232.

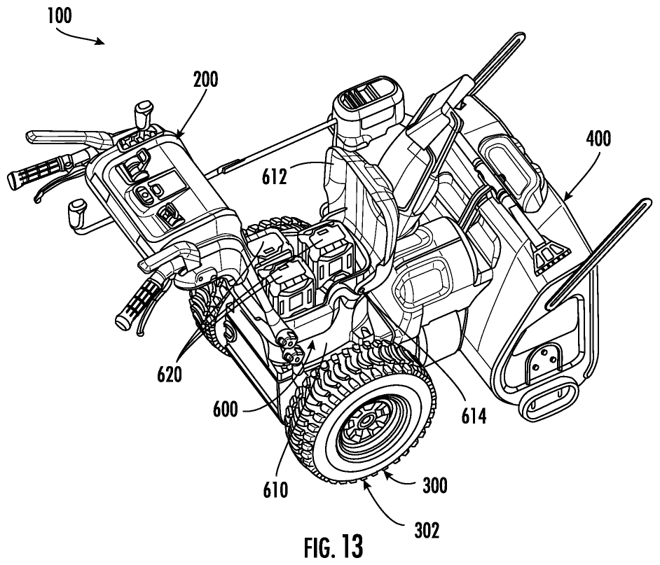

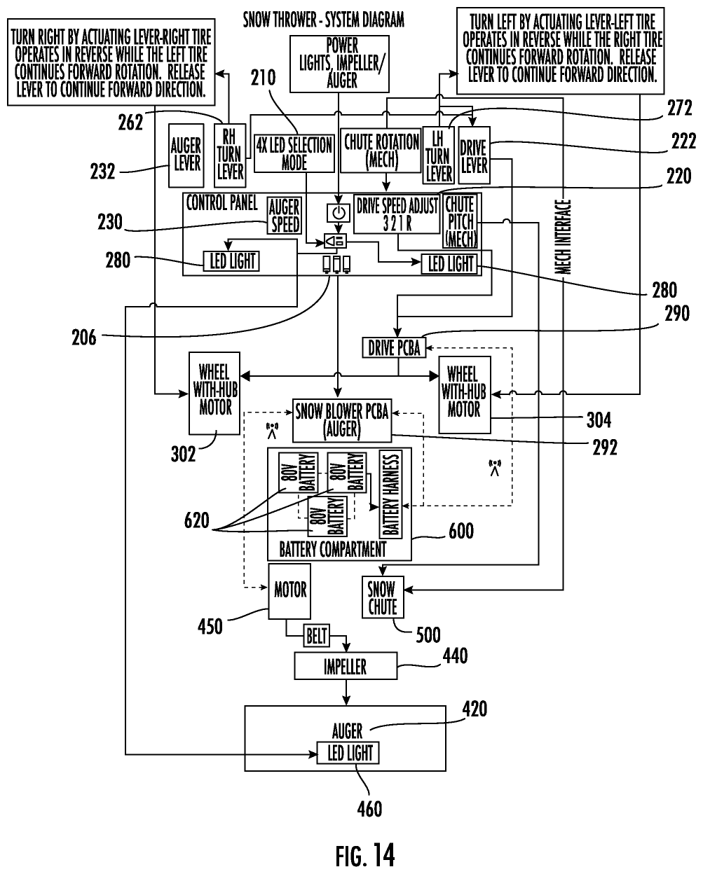

FIGS. 12 and 13 are perspective views of the illustrative snow thrower 100 with a battery cover in an open position, according to at least some aspects of the present disclosure. Referring to FIGS. 1-3, 7, 12, 13 and 14, in this exemplary embodiment, the battery assembly 600 includes a battery housing 610, a battery cover 612, one or more cover hinges 614, and a plurality of batteries 620. The batteries 620 provide power for the electrical components of the snow thrower 100 such as the lamps 212, 214, motors 310, 450, and electronic control devices 290, 292. The battery assembly 600 is mounted to the chassis 120 generally over the center axes 340 of the wheel assemblies 302, 304 which may improve traction of the wheel assemblies 302, 304. The battery assembly 600 is mounted generally centered between the wheel assemblies 302, 304 which may improve the balance and general stability of the snow thrower 100. In this illustrative example, the battery assembly 600 includes a plurality of removable batteries 620 arranged symmetrically to the center plane of the snow thrower 100. Some embodiments may include a single battery 620. In some embodiments, the batteries 620 may not be removable. The cover hinges 614 movably couple the battery cover 612 to the battery housing 610 and allow the battery cover 612 to move between an open position as shown in FIGS. 12 and 13 and a closed position as shown in FIGS. 1 and 2. When the battery cover 612 is in the open position, the batteries 620 may be removed for maintenance and/or recharging and may be replaced into the battery housing 610. When the battery cover 612 is in the closed position, the batteries 620 and the battery housing 610 may be protected from the elements such as snow and rain, for example. When installed in the battery housing 610, the batteries 620 are electrically coupled to the snow thrower 100 and provide electrical power to the various motors and controls. When the batteries 620 are installed in the battery housing 610, the battery charge indicator 206 is electrically coupled to the batteries 620. The battery charge indicator 206 may provide a perceptible indication of the remaining electric charge of the batteries 620.

Referring to FIGS. 1-5, in this illustrative embodiment, the plurality of headlamp controls 210 include an auger lamp switch 212, a control panel lamp switch 214, an all lamps switch 216, (auger lamps 212, control panel lamps 214) and an all lamps flashing switch 218 (auger lamps 212, control panel lamps 214 flashing for improved visibility, for example) A user may choose between a plurality of headlight functions: only auger lamps 460, only control panel lamps 280, all lamps 280, 460, and all lamps flashing 280, 460 (for higher visibility, for example). In this illustrative embodiment, the lamps 280, 460 are LED lamps. The lamps 280, 460 may be arc lamps, fluorescent lamps, incandescent lamps, neon lamps, or any other lamps. The lamps 280, 460 may be any combination of lamps, for example the control panel lamps 280 may be LED lamps while the auger lamps 460 may be arc lamps.

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of the general inventive concept.

What is claimed is:

1. Outdoor power equipment comprising:
a first wheel assembly comprising a first hub motor and coupled to a first side of the outdoor power equipment;
a second wheel assembly comprising a second hub motor coupled to a second side of the outdoor power equipment; and
a battery coupled to the first hub motor and the second hub motor and configured to supply electrical power to the first hub motor and the second hub motor;
wherein the first hub motor is configured to rotate the first wheel assembly to drive the outdoor power equipment; and
wherein the second hub motor is configured to rotate the second wheel assembly to drive the outdoor power equipment.

2. The outdoor power equipment of claim 1, further comprising a drive speed control coupled to the first hub motor and the second hub motor;
wherein the drive speed control is configured to control the speed of the first wheel assembly and the second wheel assembly.

3. The outdoor power equipment of claim 2, further comprising an electronic control device coupled to the drive speed control, the first hub motor, and the second hub motor;
wherein the drive speed control provides a signal to the electronic control device; and
wherein the electronic control device is configured to receive a signal from the drive speed control and control the speed of the first wheel assembly and the second wheel assembly based at least in part on the signal from the drive speed control.

4. The outdoor power equipment of claim 2, wherein the rotation of the first wheel assembly and the second wheel assembly may be controlled independently.

5. The outdoor power equipment of claim 4, further comprising:
a first hand operated drive control mechanism coupled to the first hub motor; and
a second hand operated drive control mechanism coupled to the second hub motor;
wherein the first hand operated drive control mechanism is configured to control the rotation of the first wheel assembly; and
wherein the second hand operated drive control mechanism is configured to control the rotation of the second wheel assembly.

6. The outdoor power equipment of claim 5,
wherein operating the first hand operated drive control mechanism controls the rotation of the first wheel assembly thereby turning the outdoor power equipment in a first direction; and
wherein operating the second hand operated drive control mechanism controls the rotation of the second wheel assembly thereby turning the outdoor power equipment in a second direction.

7. The outdoor power equipment of claim 5, further comprising an electronic control device coupled to the first hand operated drive control mechanism, the second hand operated drive control mechanism, the first hub motor, and the second hub motor;
wherein the first hand operated drive control mechanism provides a signal to the electronic control device;
wherein the electronic control device is configured to receive a signal from the first hand operated drive control mechanism and control the rotation of the first wheel assembly based at least in part on the signal from the first hand operated drive control mechanism;
wherein the second hand operated drive control mechanism provides a signal to the electronic control device; and
wherein the electronic control device is configured to receive a signal from the second hand operated drive control mechanism and control the rotation of the second wheel assembly based at least in part on the signal from the second hand operated drive control mechanism.

8. The outdoor power equipment of claim 5,
wherein operating both the first hand operated drive control mechanism and the second hand operated drive control mechanism at the same time controls the rotation of the first wheel assembly and the second wheel assembly in a reverse rotation direction thereby driving the outdoor power equipment in a reverse direction; and
wherein releasing either or both of the first hand operated drive control mechanism and the second hand operated drive control mechanism stops both the first wheel assembly and the second wheel assembly from rotating in a reverse rotation direction and stops driving the outdoor power equipment in a reverse direction.

9. The outdoor power equipment of claim 1, further comprising a hand operated drive mechanism coupled to the first hub motor and the second hub motor and configured to control the operation of the first hub motor and the second hub motor.

10. The outdoor power equipment of claim 9, wherein operating the hand operated drive mechanism allows the first wheel assembly and the second wheel assembly to drive the outdoor power equipment.

11. The outdoor power equipment of claim 9, further comprising an electronic control device coupled to the hand operated drive mechanism, the first hub motor, and the second hub motor;
wherein the hand operated drive mechanism provides a signal to the electronic control device; and
wherein the electronic control device is configured to receive a signal from the hand operated drive mechanism and control the rotation of the first wheel assembly and the second wheel assembly based at least in part on the signal from the hand operated drive mechanism.

12. The outdoor power equipment of claim 1, further comprising a battery charge indicator coupled to the battery and configured to provide a perceptible indication of a remaining battery electrical charge.

13. The outdoor power equipment of claim 1, wherein the battery may be removed from the outdoor power equipment for recharging.

14. The outdoor power equipment of claim 1, further comprising:
an auger rotatably coupled to the outdoor power equipment and configured to move snow,
an auger drive motor coupled to the auger and the battery and configured to drive the auger;
wherein the battery is configured to supply electrical power to the auger drive motor.

15. The outdoor power equipment of claim 14, further comprising an auger speed control coupled to the auger drive motor;
wherein the auger speed control is configured to control the speed of the auger.

16. The outdoor power equipment of claim 15, further comprising an electronic control device coupled to the auger speed control and the auger drive motor;
wherein the auger speed control provides a signal to the electronic control device; and
wherein the electronic control device is configured to receive a signal from the auger speed control and control the speed of the auger based at least in part on the signal from the auger speed control.

17. The outdoor power equipment of claim 14, further comprising a hand operated auger control mechanism coupled to the auger drive motor and configured to control the operation of the auger drive motor.

18. The outdoor power equipment of claim 17, wherein operating the hand operated auger control mechanism allows the auger drive motor to drive the auger.

19. The outdoor power equipment of claim 17, further comprising an electronic control device coupled to the hand operated auger control mechanism and the auger drive motor;
wherein the hand operated auger control mechanism provides a signal to the electronic control device; and
wherein the electronic control device is configured to receive a signal from the hand operated auger control mechanism and control the auger drive motor based at least in part on the signal from the hand operated auger control mechanism.

20. The outdoor power equipment of claim 14, further comprising:
a discharge chute rotatably coupled to the outdoor power equipment, and
a discharge chute rotation handle coupled to the discharge chute;
wherein the discharge chute may be rotated by moving the discharge chute rotation handle, and
wherein the discharge chute rotation handle is configured to prevent rotation of the discharge chute when the discharge chute rotation handle is in a locked position.
